(19) United States
(12) Patent Application Publication
(10) Pub. No.: US 2014/0356254 A1
(43) Pub. Date: Dec. 4, 2014

(54) CONTAINER FOR CENTRIFUGAL SEPARATOR

(71) Applicants: Bum Ha LEE, (US); Jung Min LEE, (US)

(72) Inventors: Bum Ha Lee, Seoul (KR); Jung Min Lee, Seoul (KR)

(21) Appl. No.: 14/361,966

(22) PCT Filed: Nov. 8, 2012
(86) PCT No.: PCT/KR2012/009379

§ 371 Date: May 30, 2014

(30) Foreign Application Priority Data
Dec. 6, 2011 (KR) 20-2011-0010834

(51) Int. Cl. B04B 15/00

(52) U.S. Cl. CPC B04B 15/00
USPC 422/548

(57) ABSTRACT

Disclosed is a container for a centrifugal separator. The container for the centrifugal separator according to the present invention is characterized in that a supporting rib formed at a connection portion comes in contact with an inner circumference of an inserting hole or an inner circumference of a bucket of the centrifugal separator in which the container is inserted and supported, although a lower cover coupled with a lower receiving portion of a body falls beyond a predetermined location. Therefore, the container does not move in the radius direction even though the centrifugal separator rotates, and thus is not damaged.

### TECHNICAL FIELD

The present invention relates to a container for centrifugal separator which separates materials having different components or specific gravities by centrifugal force.

### BACKGROUND ART

Blood, which is liquid tissue flowing in blood vessels, is broadly divided into blood cell and blood plasma. The blood cell consists of red blood cell, white blood cell and platelet, and the blood plasma mainly consisting of water includes blood coagulation factor and electrolyte which are essential for life conservation.

At present day, various methods are used for separating ingredients of the blood and extracting each ingredient of the blood for medical purpose. Furthermore, as a device for separating the ingredients of the blood, a centrifugal separator is used which utilizes the centrifugal force.

More specifically, when precipitation occurs after sampled blood is injected into the container and the container is placed in the centrifugal separator and then rotated at a predetermined rotational speed, ingredients of the blood are separated due to difference in specific gravity. That is to say, heavier blood cells form a layer in a lower part, lighter blood plasma forms a layer in an upper part, and a buffy coat layer making up about 1% of the blood is formed between the blood cells and blood plasma.

Collected in the buffy coat layer are a majority of PRP (Platelet Rich Plasma) which contains stem cells that promote cell proliferation, growth of epithelial cells, revascularization, production of collagen, production of hyaluronic acid and wound healing etc.

Accordingly, a container for centrifugal separator is required which can extract the buffy coat layer without loss.

With reference to FIG. 1, description will be made of a container for centrifugal separator of related art used for extracting buffy coat layer of the blood.

As illustrated in FIG. 1, a container for centrifugal separator (10) includes a pipe-shaped body (11) with an open top end and a cap (15) sealingly coupled with the top end of the body (11).

The body (11) has a lower receiving portion (11a), an upper receiving portion (11b) formed with a diameter approximately identical to that of the lower receiving portion (11a), and a connection portion (11c) connecting the lower receiving portion (11a) and the upper receiving portion (11b). At this time, the connection portion (11c) is formed to have a smaller diameter than those of the lower receiving portion (11a) and the upper receiving portion (11b).

Therefore, the blood cells are received in the lower receiving portion (11a), the blood plasma is received in the upper receiving portion (11b), and the buffy coat layer is received in the connection portion (11c), when precipitation occurs after sampled blood is injected into the container (10) and the container (10) is placed in a centrifugal separator (not illustrated) to be rotated at a predetermined rotational speed.

Subsequently, the buffy coat layer is sampled by extracting the buffy coat layer in such a tornado manner that a syringe needle (not illustrated) is rotated round and round while the needle is positioned in the buffy coat layer. That is, the buffy coat layer can be easily extracted and sampled only in a case where the buffy coat layer is positioned in the connection portion (11c) when the blood has been centrifuged in the container (10).

By the way, when the blood has been centrifuged, the buffy coat layer may be positioned in the lower receiving portion (11a) or in the upper receiving portion (11b) depending on the amount of blood etc. In a case where the buffy coat layer is positioned in the lower receiving portion (11a), the blood is further injected into the lower receiving portion (11a) by the use of the syringe, and in a case where the buffy coat layer is positioned in the upper receiving portion (11b), the blood cells received in the lower receiving portion (11a) are removed by the used of the syringe, and thereafter the centrifugation is performed again.

The conventional container for centrifugal separator (10) as described above has no means for adjusting a position of the buffy coat layer when the buffy coat layer is positioned in the lower receiving portion (11a) or upper receiving portion (11b), and thus has a disadvantage of being inconvenient in that the blood has to be further injected or the blood cells have to be removed by the used of the syringe.

A container for centrifugal separator which solves such a problem is disclosed in Korean Laid-Open Publication No. 10-2011-0080245 entitled “integrated separation device”.

The integrated separation device (1) includes a first lower chamber (10), a second upper chamber (20), a connection neck (30) for connecting the first chamber (10) and the second chamber (20), and a lower cover (40) coupled with a lower end portion of the first chamber (10).

Furthermore, the lower cover (40) has a lower cap (41) coupled with the first chamber (10) and having an adjustment hole formed at a center of the lower cap, an adjustment plate (42) positioned within the lower cap (41) to close the adjustment hole, and an adjustment piece (43) upward-downward movably coupled with an inner circumferential surface of the lower cap (41) and positioned below the adjustment plate (42). Thus, by adjusting a position of the adjustment piece (43) coupled with the lower cap (41), internal volume of the first chamber (10) is adjusted, thereby adjusting the position of the buffy coat layer.

By the way, the conventional integrated separation device as described above may be damaged when it is rotated while being placed in the centrifugal separator (not illustrated).

More specifically, as illustrated in FIG. 2, the integrated separation device (1) is directly inserted in an insertion hole formed in the centrifugal separator and then rotated, or is directly inserted in the insertion hole of the centrifugal separator and then rotated through a cylindrical bucket (2) having an open top end. By the way, when the adjustment piece (43) of the lower cover (40) refer to the Korean Laid-Open Publication) is lowered beyond a predetermined location, the connection neck (30) is positioned outside the insertion hole of the centrifugal separator or outside the bucket (2).

Then, an outer circumferential surface of the connection neck (30) is not supported on an inner circumferential surface of the insertion hole of the centrifugal separator or an inner circumferential surface of the bucket (2). Therefore, in rotation of the centrifugal separator, the integrated separation device (1) exposed outside the insertion hole of the centrifugal separator or outside the bucket (2) may radially move and thus be damaged.

Although formed on the outer circumferential surface of the connection neck (30) is an approximately arc-shape reinforcing rib (70) that is concave toward the inside of the connection neck (30), the reinforcing rib (70) is also not supported on the inner circumferential surface of the insertion hole of the centrifugal separator or the inner circumferential surface of the bucket (2). Therefore, in rotation of the centrifugal separator, the integrated separation device (1) is not prevented from moving.

### SUMMARY OF THE INVENTION

### Technical Problem

The present invention was made in order to solve the problems as described above, and its objects is to provide a container for centrifugal separator wherein the container with blood injected thereinto can be prevented from being damaged in rotation of the centrifugal separator by configuring the container such that an outer circumferential surface of the container always contacts with an inner circumferential surface of the bucket or an inner circumferential surface of an insertion hole of the centrifugal separator.

### Solution to Problem

For achieving the above-mentioned object, a container for centrifugal separator according to present invention is directly inserted and supported in an insertion hole formed in a centrifugal separator or is inserted and supported in the insertion hole through a bucket, a mixture where materials having different specific gravities and components are mixed is injected into the container, and the mixture is separated by centrifugal force when the container is rotated by the centrifugal separator, and the container comprises a pipe-shaped body having a lower receiving portion, an upper receiving portion positioned above the lower receiving portion, and a connection portion formed to have a smaller diameter than those of the lower receiving portion and the upper receiving portion and connecting the lower receiving portion and the upper receiving portion, the mixture being injected into the body; a lower cover which is coupled with an outer circumferential surface of the lower receiving portion so that the cover can be raised and lowered and which opens and closes an open lower end of the lower receiving portion and which adjusts the height of the mixture injected into the body, with a lower end portion of the body taken as a reference; and a plurality of supporting ribs which are formed on an outer circumferential surface of the connection portion and which contact with an inner circumferential surface of the insertion hole or an inner circumferential surface of the bucket.

### Effects of the Invention

In the container for centrifugal separator according to the present invention, even when the lower cover coupled with the lower receiving portion of the body is lowered beyond a predetermined location, the supporting ribs formed on the connection portion contacts with the inner circumferential surface of the insertion hole of the centrifugal separator in which the container is inserted and supported or with the inner circumferential surface of the bucket. Then, the container cannot radially move even when the centrifugal separator rotates, and thus the container is prevented from being damaged.

### BRIEF DESCRIPTION OF THE DRAWINGS

FIG. 1 is a perspective view of a conventional container for centrifugal separator;

FIG. 2 is a perspective view of another conventional container for centrifugal separator;

FIG. 3 is a perspective view of a container for centrifugal separator according to an embodiment of the present invention;

FIG. 4 is an exploded perspective view of FIG. 3; and

FIG. 5 is a sectional view of FIG. 3.

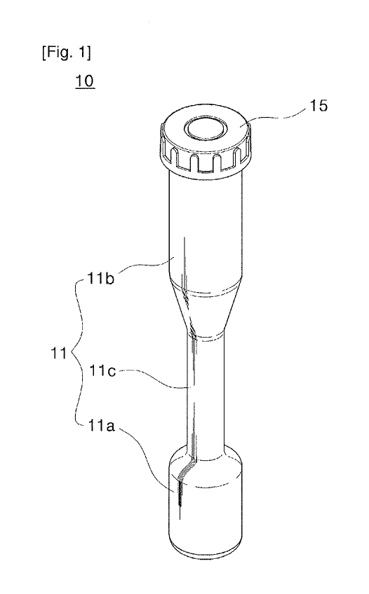

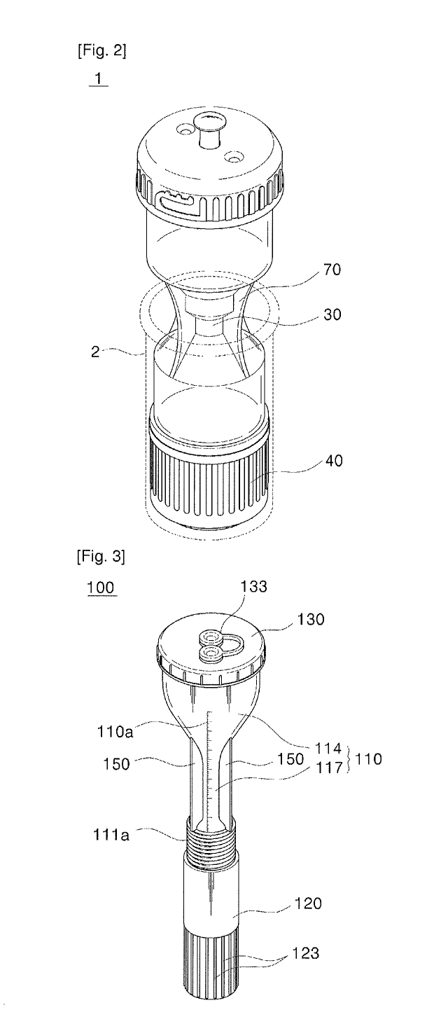

### LIST OF REFERENCE NUMERALS

110: body

111: lower receiving portion

114: upper receiving portion

117: connection portion

120: lower cover

130: upper cover

150: supporting rib

### BEST MODE FOR CARRYING OUT THE INVENTION

Detailed description of the present invention described later refers to the attached drawings illustrating by way of example particular embodiments according to which the present invention can be implemented. It should be appreciated that various embodiments of the present invention are different from one another, however, need not to be mutually exclusive. For example, specific shapes, specific structures and characteristics described in one embodiment can be realized in another embodiment without the spirit and scope of the present invention. Furthermore, it should be appreciated that positions or arrangement of individual constituent elements in each embodiment disclosed may be altered without departing from the gist and scope of the present invention. Therefore, detailed description described later is not intended to be restrictive, and the scope of the present invention is limited by appended claims and its equivalent, if properly described. Length, area, thickness and form in embodiments illustrated in the drawings may be exaggerated for the sake of convenience.

Hereinafter, a container for centrifugal separator according to an embodiment of the present invention will be described in detail with reference to the attached drawings.

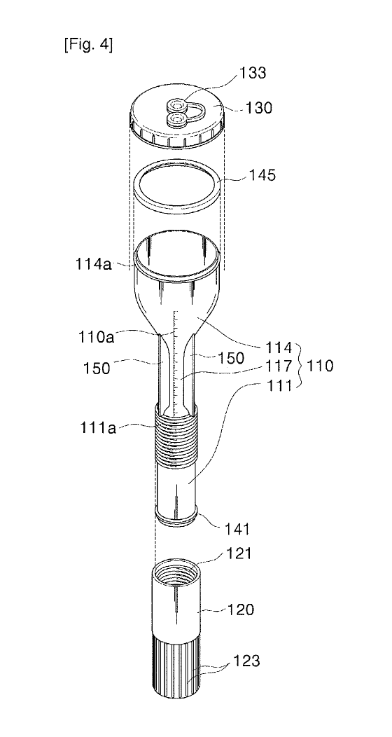

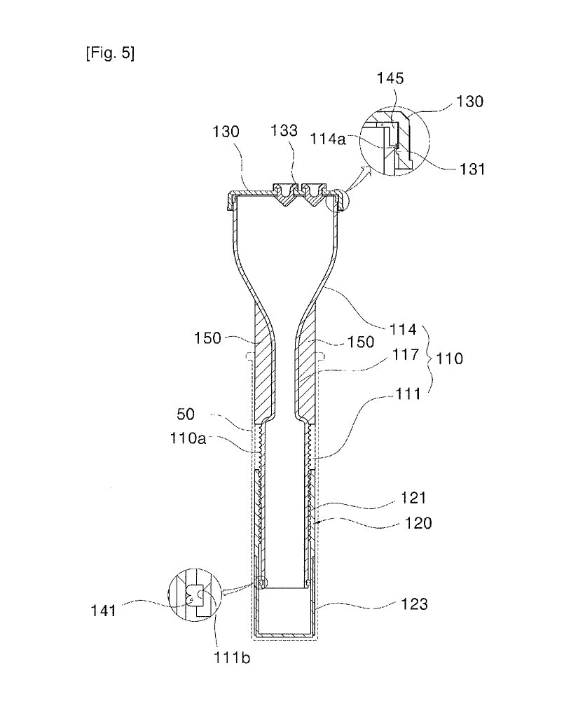

FIG. 3 is a perspective view of a container for centrifugal separator according to an embodiment of the present invention, FIG. 4 is an exploded perspective view of FIG. 3, and FIG. 5 is a sectional view of FIG. 3.

As illustrated in the figures, the container for centrifugal separator (100) according to the present embodiment includes a body (110), a lower cover (120) and an upper cover (130). The container (100) is directly inserted and supported in an insertion hole formed in the centrifugal separator(not illustrated), or is inserted and supported in the insertion hole of the centrifugal separator through a bucket (50) (refer to FIG. 5). Injected into the container (100) is a mixture, such as blood, where materials having different specific gravities and components are mixed, and when the container (100) is rotated by the centrifugal separator, the mixed materials are separated by centrifugal force.

The body (110) is formed in the form of pipe with open upper and lower ends, and has a lower receiving portion (111), an upper receiving portion (114) positioned above the lower receiving portion (111), and a connection portion (117) formed between the lower receiving portion (111) and the upper receiving portion (114) to connect the lower receiving portion (111) and the upper receiving portion (114). At this time, the connection portion (117) is formed to have a smaller diameter than those of the lower receiving portion (111) and the upper receiving portion (111).

A lower cover (120) is coupled with an outer circumferential surface of the lower receiving portion (111), and opens and closes an open lower end of the body (110), i.e., an open lower end of the lower receiving portion (111). At this time, the lower cover (120) is coupled with the lower receiving portion (111) such that the cover can be raised and lowered. Therefore, by adjusting a position of the lower cover (120) coupled with the lower receiving portion (111), the height of the mixture injected into the body (110) is adjusted, with the lower end portion of the body (110) taken as a reference.

Spiral portions (111a, 121) engaging each other are formed on the outer circumferential surface of the lower receiving portion (111) and an inner circumferential surface of the lower cover (120), respectively so that the lower cover (120) coupled with the outer circumferential surface of the lower receiving portion (111) can be raised and lowered. Therefore, the lower cover (120) is raised or lowered along the lower receiving portion (111) as the lower cover (120) is rotated in forward or reverse direction with respective to the lower receiving portion (111).

A plurality of protruding rails (123) are formed on an outer circumferential surface of the lower cover (120). The protruding rails (123) prevent a user's hand from slipping when the user holds and rotates the lower cover (120) by his/her hand.

Arranged on the outer circumferential surface of the lower receiving portion (111) is a sealing member (141), such as O-ring, which provides seal between the lower receiving portion (111) and the lower cover (120). Furthermore, formed on the outer circumferential surface of the lower receiving portion (111) is a ring-shaped seating groove (111b) in which the sealing member (141) is inserted and seated (refer to FIG. 5). Since the sealing member (141) is inserted and seated in the seating groove (111b), the sealing member (141) is prevented from being raised or lowered due to the raising or lowering of the lower cover (120).

The upper cover (130) is coupled with an outer circumferential surface of the upper receiving portion (114), and opens and closes an open upper end of the body (110), i.e., an open upper end of the upper receiving portion (114).

Also arranged on the outer circumferential surface of the upper receiving portion (114) is a sealing member (145), such as O-ring, which provides seal between the upper receiving portion (114) and the upper cover (130). Furthermore, formed on the outer circumferential surface of the upper receiving portion (114) is a catch rim (114a) for preventing the sealing member (145), which is pressed downward from above by the upper cover (130), from deviating toward a lower side of the upper receiving portion (114).

A catch shoulder (131) formed on an inner circumferential surface of the upper cover (130) is caught on a lower surface of the catch rim (114a) (refer to FIG. 5). The catch rim (114a) and the catch shoulder (131) prevent the upper cover (130) from deviating from the upper receiving portion (114).

The body (110) is formed from transparent material so that the mixture can be observed from the outside, and graduations (110a) indicating the amount of the mixture may be marked on the outer circumferential surface of the body (110).

A method for using the container (100) according to the present embodiment will be described, taking the blood for example.

With the body (110) closed by the lower cover (120 and the upper cover (130), sampled blood is injected into the body (110) by the use of the syringe etc., and the container (100) is placed in the centrifugal separator and then rotated at a predetermined rotational speed, and thereafter precipitation occurs.

Then, heavier blood cells form a layer in the lower receiving portion (111), lighter blood plasma forms a layer in the upper receiving portion (114), and the buffy coat layer formed between the blood cells and the blood plasma is positioned in the connection portion (117). Therefore, the buffy coat layer positioned in the connection portion (117) can be extracted in a tornado manner.

By the way, the buffy coat layer may not be positioned in the connection portion (117), depending on the amount of blood initially injected etc. When the buffy coat layer is positioned in the lower receiving portion (111), the lower cover (120) is rotated in the forward direction to be raised, whereby the buffy coat layer is positioned in the connection portion (117), and in such a state, the centrifugation is performed again. Also, when the buffy coat layer is positioned in the upper receiving portion (114), the lower cover (120) is rotated in the reverse direction to be lowered, whereby the buffy coat layer is positioned in the connection portion (117), and in such a state, the centrifugation is performed again.

By the way, when the body (100) is inserted in the insertion hole of the centrifugal separator or in the bucket (50) with the lower cover (120) lowered beyond the predetermined location, the connection portion (117) is positioned outside the insertion hole of the centrifugal separator or outside the bucket (50). Then, a space between an inner circumferential surface of the insertion hole of the centrifugal separator and an outer circumferential surface of the connection portion (117) or a space between an inner circumferential surface of the bucket (50) and the outer circumferential surface of the connection portion (117) is widened, and thus the container (100) may radially move due to rotation of the centrifugal separator and thus be damaged.

For preventing this, the container for centrifugal separator (100) according to the present embodiment is formed with a plurality of supporting ribs (150).

More specifically, on the outer circumferential surface of the connection portion (117), the plurality of supporting ribs (150) are formed along a longitudinal direction of the body (110) and radially with respect to a center of the body (110). The supporting ribs (150) contact with the inner circumferential surface of the insertion hole of the centrifugal separator or the inner circumferential surface of the bucket (50).

Then, even when the lower cover (120) is lowered beyond the predetermined location, the container (100) is prevented from radially moving, since the supporting ribs (150) contact with the inner circumferential surface of the insertion hole of the centrifugal separator or the inner circumferential surface of the bucket (50). Thus, the container (100) is prevented from being damaged.

Reference numeral “133” (not described) in FIGS. 3 to 5 designates a soft membrane for insertion of the syringe needle.

The drawings for the embodiment of the present invention described above is schematically shown such that parts associated with the technical concepts of the present invention can be easily understood, with detailed outlines omitted. Furthermore, the above-described embodiment is cannot be a basis for limiting the technical concepts of the present invention, rather is only a reference for understanding technical matters included in the claims of the present invention.

1. A container for centrifugal separator, wherein the container is directly inserted and supported in an insertion hole formed in a centrifugal separator or is inserted and supported in the insertion hole through a bucket, a mixture where materials having different specific gravities and components are mixed is injected into the container, and the mixture is separated by centrifugal force when the container is rotated by the centrifugal separator, and the container comprising:
a pipe-shaped body having a lower receiving portion, an upper receiving portion positioned above the lower receiving portion, and a connection portion formed to have a smaller diameter than those of the lower receiving portion and the upper receiving portion and connecting the lower receiving portion and the upper receiving portion, the mixture being injected into the body;
a lower cover which is coupled with an outer circumferential surface of the lower receiving portion so that the cover can be raised and lowered and which opens and closes an open lower end of the lower receiving portion and which adjusts the height of the mixture injected into the body, with a lower end portion of the body taken as a reference; and
a plurality of supporting ribs which are formed on an outer circumferential surface of the connection portion and which contact with an inner circumferential surface of the insertion hole or an inner circumferential surface of the bucket.

2. The container for centrifugal separator according to claim 1, wherein an upper end of the upper receiving portion is open, and an upper cover is coupled with an outer circumferential surface of the upper receiving portion, the upper cover opening and closing the upper end of the upper receiving portion.

3. The container for centrifugal separator according to claim 1, wherein a sealing member is arranged on the outer circumferential surface of the lower receiving portion for providing seal between the lower receiving portion and the lower cover.

4. The container for centrifugal separator according to claim 3, wherein formed on the outer circumferential surface of the lower receiving portion is a ring-shaped seating groove in which the sealing member is inserted and seated.

5. The container for centrifugal separator according to claim 2, wherein provided on the outer circumferential surface of the upper receiving portion is a sealing member for providing seal between the upper receiving portion and the upper cover.

6. The container for centrifugal separator according to claim 5, wherein formed on the outer circumferential surface of the upper receiving portion is a catch rim for preventing the sealing member from deviating toward a lower side of the upper receiving portion.

7. The container for centrifugal separator according to claim 6, wherein formed on an inner circumferential surface of the upper cover is a catch shoulder which is caught on the catch rim.

8. The container for centrifugal separator according to claim 1, wherein spiral portions engaging each other are formed on the outer circumferential surface of the lower receiving portion and an inner circumferential surface of the lower cover, respectively.

9. The container for centrifugal separator according to claim 8, wherein a plurality of protruding rails are formed on an outer circumferential surface of the lower cover.

10. The container for centrifugal separator according to claim 1, wherein the body is formed of transparent material, and graduations are marked on an outer circumferential surface of the body.
